(19) United States
(12) Patent Application Publication
(10) Pub. No.: US 2022/0242707 A1
(43) Pub. Date: Aug. 4, 2022

(54) Method and System for Removing and Storing Vehicle Hard Tops

(71) Applicant: Marc Petersen, Gibson City, IL (US)

(72) Inventor: Marc Petersen, Gibson City, IL (US)

(21) Appl. No.: 17/167,029

(22) Filed: Feb. 3, 2021

(51) Int. Cl. B66F 7/26; B60J 7/10; B66C 23/20; B66C 23/84; B66C 23/82

(52) U.S. Cl. CPC B66F 7/26; B60J 7/106; B66C 23/82; B66C 23/84; B66C 23/201

(57) ABSTRACT

A method and system for removing and storing vehicle hard tops is disclosed. The hard top removal system is comprised of a rack with webbing straps, a ceiling anchor, a wall anchor, a lifting line, pulleys and a winch. An object of the invention is to provide an easy means to remove and store a vehicle hard top when the vehicle is parked in a typical residential garage.

### FIELD OF THE INVENTION

The invention relates to automotive vehicles. More specifically, it relates to a novel system and method for removing and storing vehicle hard tops.

### BACKGROUND

The first hardtops evolved on automobiles in the early 1900s on ‘touring sedans’ or ‘Springfields.’ The Springfield design featured folding upper frames on the doors and the rear glass frames were removable and stored under or behind the seats. In the late teens, Cadillac offered a sedan with removable ‘B’ pillars. Another form of early pillarless hardtop was the ‘California top,’ originating in Los Angeles. These hard tops were designed to replace the folding roofs of touring cars, in order to enclose the sides of the car for better weather protection. The hard tops were frequently equipped with celluloid windows that retracted like a roller blind for open sided motoring offering a low-cost compromise between an open and closed car. Mass-production of hardtops began with General Motors, which launched two-door, pillarless hardtops in 1949 as the Buick Roadmaster Riviera, Oldsmobile 98 Holiday, and Cadillac Coupe de Ville. They were purportedly inspired by the wife of a Buick executive who always drove convertibles, but never lowered the top. In 1955, General Motors introduced the first four-door hardtops. Following the pattern established by the two-door variants, GM utilized the same special sub-designations for the pillarless four-door body types within all their brands in North America. Other manufacturers also designated special names for their pillarless models. Ford called them Victoria, Chrysler used Newports, Packard named them Mayfair, and Hudson's were Hollywoods. Nash used the Country Club moniker while pillarless Studebakers were Starliners, a name that was later used by Ford for its Galaxie hardtop. After World War II Jeeps became extremely popular and later in the 1990s Jeep models included a removable hard top. As jeep hard tops were in demand, the vehicle industry began developing hard top removal systems for residential garages. Unites States Patent No.s US20090309079A1 and U.S. Pat. No. 2,859,881A granted to Louis Lacina and William C. Coryell respectively disclosed a Jeep hard top removal system; however, they are standalone systems and do not affix to a garage's roof or walls. Unites States Patent No. US20120155997A1 granted to Gary Pawlak disclosed a truck cap removal system that relies on an expensive hydraulic ram. Unites States Patent No. US20180290701A1 granted to Larry Stirling disclosed a hard top storage system; however, it does not aid in the removal of a top. While many patents exist that assist users in removing and storing vehicle hard tops from above a vehicle; none were found that appear to rely on affordable cables pulleys and winches.

### SUMMARY OF THE INVENTION

An object of the present invention is to provide a system to easily remove a hard top from a vehicle. The system is a hoist that a single user can use to raise a top above a vehicle.

Another object of the invention is to allow for the raising of a hard top to be balanced. The system includes an anchor bar with straps. Each strap is adjustable and allows for the load of the hard top to be balanced before the full raising takes place.

Another object of the invention is to leverage a user's existing garage as a frame work for the hard top removal system. The rack, pulleys and winch are designed to be attached to existing wall and ceiling studs and requires no derricks or stanchions.

Another object of the invention is to allow a hard top to be stored inside a residential garage. The hard top removal system raises the top above a vehicle and can remain elevated for storage safely over extended periods using the wire cabling.

Another object of the invention is to allow the raising and lowering of the hard top removal system to be performed either manually or automatically. The winch has a spool that accepts both a handle to turn it manually or a drill attachment to turn it automatically.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the apparatus, but should not be considered as placing limitations thereon.

### BRIEF DESCRIPTION OF THE FIGURES

FIG. 1 showing perspective view of the apparatus;

FIG. 2 showing a close up view of the apparatus; and

FIG. 3 showing a representative view of the method.

### DETAILED DESCRIPTION OF THE FIGURES

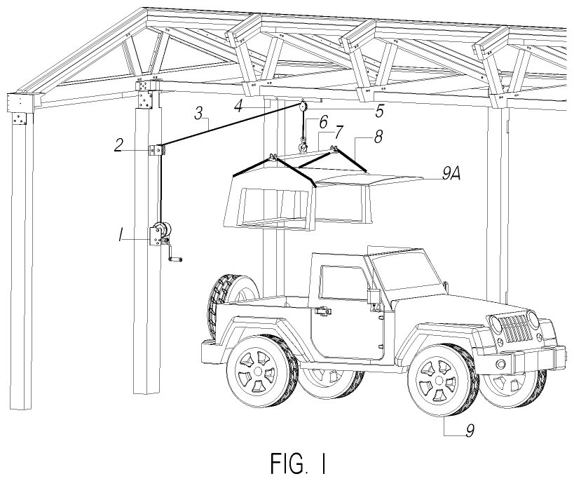

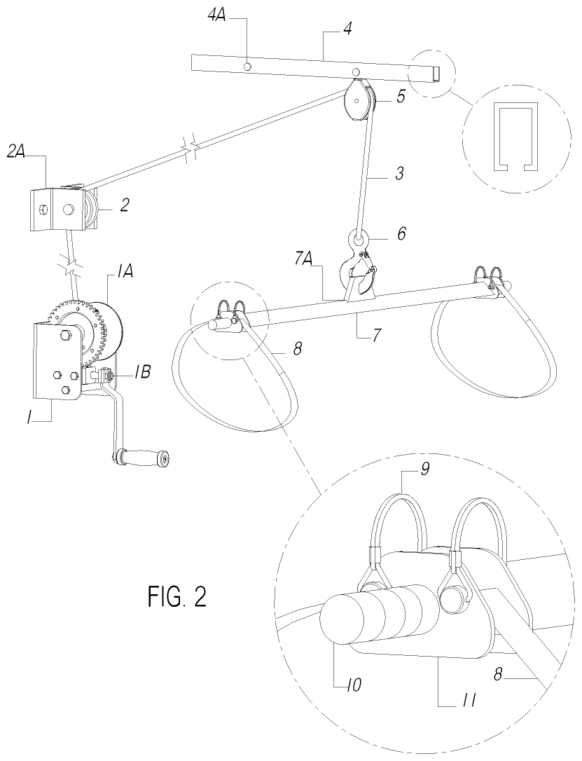

FIG. 1 showing a preferred embodiment of the apparatus comprised of bar 7 connected to vehicle 9's hard top 9A by means of at least two straps 8 and hook 6. Said bar 7 being connected to selectively-lockable winch 1 by means of hook 6 and lifting line 3 (made of a material including but not limited to metal wire rope, steel cable, nylon etc.), guided by corner-mounted pulley 2 with L-shaped flanges, and ceiling-mounted pulley 5 attached to ceiling rail 4. Said L-shaped flanges on corner-mounted pulley 2 allow corner-mounted pulley 2 to be bolted to a wall. FIG. 2 showing a close up view of the apparatus. Bar 7 being comprised of a triangular-shaped tube made of a rigid material such as but not limited to metal, plastic and the like and having cylindrical-shaped handles 10 with grips on each distal end. Bar 7 also having a triangular shaped connection 7A with aperture disposed proximally thereon. Said handles 10 being connected to bar 7 by means of anchor channel 11 and having at least two bail locking pins 9 disposed perpendicular to said channel 11 and connected to loops in straps 8. Straps 8 comprised of a flexible yet rigid material such as but not limited to nylon webbing, cable, rope, chains and the like and being adjustable with selective anchor methods including but not limited to Velcro, buckles, snaps and the like to accommodate different-size hard tops 9A therein.

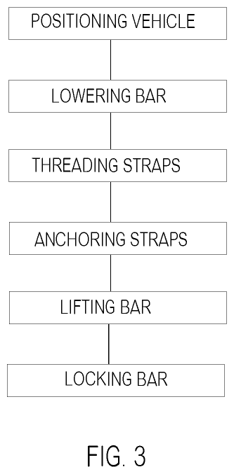

The figure also showing ceiling-mounted pulley 5 being connected to U-shaped ceiling rail 4 by means of bolts 4A and rail 4 being connected to a ceiling rafter by means of bolts and washers passing through a plurality of apertures therein. Ceiling rail 4 being made of a rigid material such as but not limited to steel, aluminum and the like. FIG. 2 also showing corner-mounted pulley 2 having L-shaped plates 2A allowing it to be mounted to a wall stud with screws and winch 1 having a selectively-locking spool 1A and removable handle 1B allowing it to raise and lower lifting line3 by a user's hands or by an electric drill etc. FIG. 3 showing a representative view of the apparatus' method including but not limited to: positioning a vehicle's hard top 9A beneath bar 7; attaching hook 6 to an aperture on connection 7A on bar 7; lowering bar 7 by means of rotating winch 1; affixing straps to bar 7 by means of bail locking pins 9; threading straps 8 to vehicle's hard top 9A; lifting hard top 9a using winch 1; and locking hard top 9A by locking the spool on winch 1.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

What is claimed is:

1.) A system for raising and storing a vehicle hard top comprised of the following parts:
a) straps for connecting to the vehicle hard top;
b) a bar for connecting the straps;
c.) a lifting line for raising and lowering the bar;
d.) a ceiling-mounted pulley and a corner-mounted pulley for guiding the lifting line;
e.) a ceiling rail for attaching the ceiling mounted pulley to a ceiling; and
f.) a winch for raising and lowering the lifting line.

2.) The system for raising and storing a vehicle hard top of claim 1 wherein the bar having bail locking pins on distal ends to connect to loops in said straps.

3.) The system for raising and storing a vehicle hard top of claim 1 wherein the bar having a connection with aperture to receive a hook on the lifting line.

4.) The system for raising and storing a vehicle hard top of claim 1 wherein the ceiling—mounted pulley is connected to a ceiling by means of the ceiling rail.

5.) The system for raising and storing a vehicle hard top of claim 1 wherein the corner-mounted pulley is connected to a wall by means of L-shaped flanges and bolts.

6.) The system for raising and storing a vehicle hard top of claim 1 wherein the winch having a selectively-locking spool and handle that can be turned manually using hands or automatically using a drill.

7.) A method for raising and storing the vehicle's hard top comprised of the following steps:
a) positioning a vehicle's hard top beneath the bar;
b) attaching the hook to the connection on the bar;
c) lowering the bar;
d) affixing the straps to the bar;
e) threading straps to the vehicle's hard top;
f) raising the vehicle's hard top; and
g) locking the vehicle's hard top.

8.) The method for raising and storing the vehicle's hard top of claim 5 wherein the attaching the hook includes the step of attaching the hook to an aperture in the connection on the bar.

9.) The method for raising and storing the vehicle's hard top of claim 5 wherein the lowering the bar includes the step of the turning the handle on the winch.

10.) The method for raising and storing the vehicle's hard top of claim 5 wherein the affixing the straps to the bar includes the steps of attaching the straps to bail locking pins on the bar.

11.) The method for raising and storing the vehicle's hard top of claim 5 wherein the raising the vehicle's hard top includes the step of turning the winch handle.

12.) The method for raising and storing the vehicle's hard top of claim 5 wherein the locking the hard top includes the step of locking the spool on the winch.
